(19) United States
(12) Patent Application Publication
(10) Pub. No.: US 2024/0420172 A1
(43) Pub. Date: Dec. 19, 2024

(54) FREE CHARGEABLE VOUCHER-BASED CONTENT PROVIDING SYSTEM

(71) Applicant: KAKAO ENTERTAINMENT CORP., Seongnam-si, Gyeonggi-do (KR)

(72) Inventors: Jeong Won Park, Seoul (KR); Yun Ho Park, Gwangju-si, Gyeonggi-do (KR); Yong Jin Kim, Seoul (KR); Gwang Su Lee, Goyang-si, Gyeonggi-do (KR)

(21) Appl. No.: 18/262,856

(22) PCT Filed: Jan. 19, 2022
(86) PCT No.: PCT/KR2022/000948

§ 371 Date: Jul. 25, 2023

(30) Foreign Application Priority Data
Jan. 27, 2021 (KR) 10-2021-0011740
Jan. 18, 2022 (KR) 10-2022-0007149

(51) Int. Cl. G06Q 30/0207

(52) U.S. Cl. CPC G06Q 30/0221

(57) ABSTRACT

A free chargeable voucher-based content providing system for providing a plurality of pieces of content on the basis of a free chargeable voucher, comprising: a voucher management unit which manages a free chargeable voucher that allows content to be used for free, sets a plurality of pieces of target content, which are subject to the free chargeable voucher, among the plurality of pieces of content, and automatically charges a certain number of free chargeable vouchers to a user terminal at certain time intervals; a content providing unit which, when a request is received from the user terminal to provide target content on the basis of the free chargeable voucher, provides the target content to the user terminal; and a storage unit which stores content information regarding the plurality of pieces of content, setting information, and voucher information regarding charging and use of the free chargeable voucher.

### TECHNICAL FIELD

The present invention relates to a technology for providing content to a user based on a voucher, and more specifically, to a method and system for providing content to a user based on a free chargeable voucher that is automatically charged and granted to the user after a certain period of time has elapsed.

### BACKGROUND ART

It is common for modern people living busy lives to receive various content such as cartoons, dramas, and movies using smart phones thanks to the development of information and communication technology through the internet.

Providing the content through the smart phone is generally performed through a platform that provides the content service. Content consumers access the platform that provides desired content through the smart phone, and the smart phone downloads data used to execute the corresponding content and provides the corresponding content to the consumers.

These platforms generate revenue in two main ways. First, there is a free-based content providing platform that increases platform users by providing content for free, and generates revenue through advertisements based on the increased users, and a paid-based content providing platform that generates revenue by providing content for a fee.

In the past, it was a general online consumption environment that there was a great reluctance to pay for content consumption. For that reason, platforms that provide free content have been more dominant.

However, since the free content providing platform generates revenue by indirect means such as advertisements, it is difficult to stably provide various content, and it is limited to have a high-performance content providing environment. In particular, there was a problem in that user convenience is greatly reduced because advertisements may be overused to maximize profits.

On the other hand, in the case of a paid content providing platform, many consumers are reluctant to purchase content for a fee because of doubts as to whether the content will satisfy the needs of consumers after purchasing the content for a fee.

Under this situation, the present applicant introduced a so-called wait-and-free business model to provide content services such as webtoons and web novels. The method of allowing content to be viewed for free after waiting for a certain period of time greatly increases the influx of users into the platform and enables users to consume paid content naturally, driving the growth of the paid content market such as webtoons and web novels and related ecosystems.

### DISCLOSURE

### Technical Tasks

An object of the present invention is to provide a free chargeable voucher-based content providing method and system that can improve loyalty and dependence on a content providing service.

In addition, an object of the present invention is to provide a free chargeable voucher-based content providing method and system that can help users reasonably consume.

The technical objects to be achieved in the present invention are not limited to the technical object mentioned above, and other technical objects not mentioned will be clearly understood by those skilled in the art from the following description.

### Technical Solutions

In order to solve the above tasks, the present invention provides a free chargeable voucher-based content providing system for providing a plurality of pieces of content on the basis of a free chargeable voucher, the system comprising: a voucher management unit which manages a free chargeable voucher that allows a plurality of pieces of content to be used for free, sets a plurality of pieces of target content, which are subject to the free chargeable voucher, among the plurality of pieces of content, and automatically charges a certain number of free chargeable vouchers to a user terminal at certain time intervals; a content providing unit which, when a request is received from the user terminal to provide target content on the basis of the free chargeable voucher, provides the target content to the user terminal; and a storage unit which stores content information regarding the plurality of pieces of content, setting information regarding setting of the plurality of pieces of target content, and voucher information regarding charging and use of the free chargeable voucher.

Here, the voucher management unit may set the time and number of charging of the free chargeable voucher.

In addition, when a request is received from the user terminal to provide target content, the voucher management unit may grant the user terminal the right to view the target content while exhausting the free chargeable voucher.

In addition, the free chargeable voucher can be used until the next charging.

The free chargeable voucher-based content providing system of the present invention may further include an information providing unit that provides content information, setting information regarding setting of a plurality of pieces of target content, and voucher information to the user terminal.

In addition, the user terminal may expose a floating button including voucher information on the main home screen.

Here, the floating button may be exposed in a reduced form when the main home screen is scrolled or when all of the free chargeable vouchers are exhausted.

In addition, the floating button may display a badge indicating the free chargeable voucher and the remaining number of the free chargeable vouchers.

In addition, the user terminal may display a plurality of category tabs corresponding to a plurality of categories in which a plurality of pieces of content are classified by type on the main home screen.

Further, when the user selects one of the plurality of category tabs, the user terminal may move to a category home screen corresponding to the selected category tab.

In addition, the user terminal may expose the floating button in a reduced form on the category home screen.

In addition, the user terminal may display free use tabs corresponding to the plurality of pieces of target content on the main home screen.

In addition, when the user selects the free use tab, the user terminal may move to a free use home screen corresponding to the target content.

In addition, when the user selects the floating button, the user terminal may move to a free use home screen corresponding to the target content.

In addition, the user terminal may display a storage box tab corresponding to a storage box for storing the free chargeable voucher on the main home screen.

In addition, the user terminal may expose a badge indicating the free chargeable voucher on the storage tab for a certain period of time after charging the free chargeable voucher.

In addition, the user terminal may expose a badge indicating the free chargeable voucher on the plurality of pieces of target content.

### Effects

According to the present invention, since the free chargeable voucher can be used for any content subject to the free chargeable voucher and can be used until the next charging, the user wants to use the free chargeable voucher as much as possible before the next charging, and the frequency of using the free chargeable voucher-based content providing services increases. As a result, there is an effect of increasing the user's loyalty and dependence on the free chargeable voucher-based content providing services.

In addition, when the free chargeable voucher is used for a lot of content, the user can more reliably decide whether or not to purchase the experienced content. After all, it can help the user's rational consumption.

The effects obtainable in the present invention are not limited to the effects mentioned above, and other effects not mentioned will be clearly understood by those skilled in the art from the following description.

### BRIEF DESCRIPTION OF THE DRAWINGS

FIG. 1 is a schematic configuration diagram of a free chargeable voucher-based content providing system according to an embodiment of the present invention.

FIG. 2 is a diagram for explaining a process of charging a free voucher in a free chargeable voucher-based content providing system according to an embodiment of the present invention.

FIG. 3 is a view for explaining a process of providing content based on a free chargeable voucher.

FIG. 4 is a diagram illustrating a main home screen displayed on a user terminal in a free chargeable voucher-based content providing system according to an embodiment of the present invention.

FIG. 5 is a diagram illustrating the main home screen when scrolled or when all of the free chargeable vouchers are exhausted in FIG. 4.

FIGS. 6 and 7 are diagrams illustrating a category home screen displayed on a user terminal in a free chargeable voucher-based content providing system according to an embodiment of the present invention.

FIG. 8 is a diagram illustrating a free use home screen displayed on a user terminal in a free chargeable voucher-based content providing system according to an embodiment of the present invention.

FIG. 9 is a diagram illustrating a target content home screen displayed on a user terminal in a free chargeable voucher-based content providing system according to an embodiment of the present invention.

FIG. 10 is a diagram illustrating a target content list screen displayed on a user terminal in a free chargeable voucher-based content providing system according to an embodiment of the present invention.

FIG. 11 is a diagram illustrating a description of a free chargeable voucher displayed on a user terminal in a free chargeable voucher-based content providing system according to an embodiment of the present invention.

### DETAILED DESCRIPTION OF EMBODIMENTS

Hereinafter, the embodiments disclosed in the present specification will be described in detail with reference to the accompanying drawings, but the same or similar components regardless of reference numerals are assigned the same reference numerals, and redundant description thereof will be omitted. The suffixes “module” and “unit” for components used in the following description are given or used together in consideration of only the ease of writing the specification, and do not have meanings or roles that are distinct from each other by themselves. In addition, in describing the embodiments disclosed in the present specification, if it is determined that detailed descriptions of related known technologies may obscure the gist of the embodiments disclosed in this specification, the detailed description thereof will be omitted. In addition, the accompanying drawings are only for easy understanding of the embodiments disclosed in the present specification, and the technical idea disclosed in the present specification is not limited by the accompanying drawings, and should be understood to include all modifications, equivalents, and substitutes included in the spirit and scope of the present invention.

Terms including an ordinal number, such as first, second, etc., may be used to describe various elements, but the elements are not limited by the terms. The above terms are used only for the purpose of distinguishing one component from another.

When a component is referred to as being “connected” or “coupled” to another component, it should be understood that although they may be directly connected or coupled to each other, other components may exist in the middle. On the other hand, when a component is referred to as “directly connected” or “directly coupled” to another component, it should be understood that no other component exists in the middle.

Singular expressions include plural expressions unless the context clearly implies otherwise.

In the present application, terms such as “comprise” or “have” are intended to designate that a feature, number, step, operation, component, part or combination thereof described in the specification is present, but should not be construed to preclude the possibility of the presence or addition of one or more other features, numbers, steps, operations, components, parts or combinations thereof.

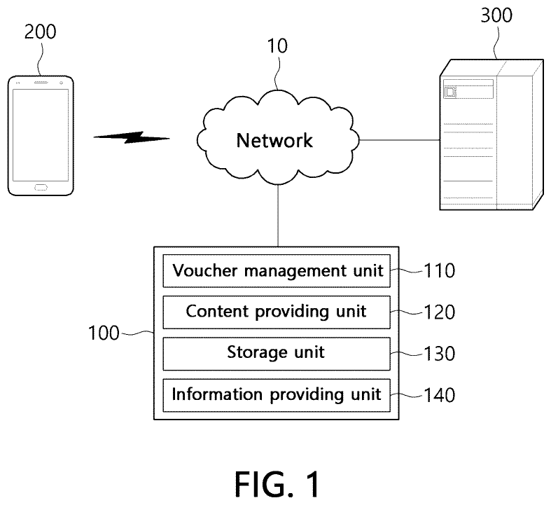

FIG. 1 is a schematic configuration diagram of a free chargeable voucher-based content providing system according to an embodiment of the present invention.

Referring to FIG. 1, a free chargeable voucher-based content providing system according to an embodiment of the present invention is a system that provides a plurality of pieces of content based on a free chargeable voucher to a user terminal 200, and may be configured to include a server 100 and a user terminal 200. Here, the server 100 is configured to be able to communicate with the user terminal 200 through the network 10.

In addition, the free chargeable voucher-based content providing system according to an embodiment of the present invention may further include an external server 300 such as a financial institution server for payment of a content voucher and a content providing server for providing the provision of a content provider. Here, the external server 300 is configured to be able to communicate with the server 100 and the user terminal 200 through the network 10.

Content is a concept that refers to information or individual information elements that can be implemented as text, image, video, audio, or a combination thereof and provided to a user, and may include text (e.g., web novels, other digital books), a combination of text and images (e.g., webtoons), and videos provided through a platform accessed by multiple users.

A content provider is a concept that refers to a subject that provides content, and means an online service provider that provides content to users (or subscribers) for a fee or free. For example, the content provider may include a TV broadcasting station, a radio broadcasting station, a video on demand (VOD) provider, an audio on demand (AOD) provider, and the like.

The communication method through the network 10 between the server 100, the user terminal 200 and the external server 300 may include various communication methods through which objects may network with each other, and may be wired communication, wireless communication, 3G, 4G, 5G wired internet or wireless internet, and further may be a core network integrated with wired public network, wireless mobile communication network, or mobile internet, etc., and an open computer network providing TCP/IP protocol and various services existing in the upper layer thereof, such as HTTP (Hyper Text Transfer Protocol), Telnet, FTP (File Transfer Protocol), DNS (Domain Name System), SMTP (Simple Mail Transfer Protocol), etc., but is not limited thereto. For example, the network 2 may refer to a communication network based on one or more communication methods selected from the group consisting of a local area network (LAN), a metropolitan area network (MAN), global system for mobile network (GSM), enhanced data GSM environment (EDGE), high speed downlink packet access (HSDPA), wideband code division multiple access (W-CDMA), code division multiple access (CDMA), time division multiple access (TDMA), bluetooth, zigbee, Wi-Fi, voice over internet protocol (VOIP), LTE advanced, IEEE802.16m, wireless MAN-advanced, HSPA+, 3GPP long term evolution (LTE), mobile WiMAX (IEEE 802.16e), UMB (formerly EV-DO Rev. C), flash-OFDM, iBurst and MBWA (IEEE 802.20) systems, HIPERMAN, beam-division multiple access (BDMA), Wi-MAX (world interoperability for microwave access), but is not limited thereto.

The free chargeable voucher-based content providing system according to an embodiment of the present invention may provide content to the user terminal 200 using the voucher.

Here, the voucher is not necessarily limited to being paid using real money, and may be paid using electronic money or the like. For example, the means for purchasing the voucher may be made in several ways, such as immediate payment, regular payment, or electronic gift certificate, and is not limited to a specific method.

Such a voucher may be purchased as an entire content voucher, but may also be purchased as a single voucher corresponding to each individual content.

The use scope of the voucher may be set in several ways. In one example, if the content is a video of a series with a plurality of episodes, the voucher may be set to be usable for each episode of the series when purchasing the voucher. For example, the user may use the voucher use one by one when viewing one or more videos of a specific episode.

In an embodiment, the voucher includes a payment voucher based on electronic money or real money, and a voucher based on non-payment. Here, the payment voucher includes a temporary voucher that allows the user to use the content for a certain period of time (e.g., rental right, etc.), and a non-temporary voucher that allows the user to use the content for a predetermined time or more (e.g., a collection right, etc.).

The non-payment-based voucher includes an initial voucher that allow a preset number of content to be used for free (e.g., free vouchers from episodes 1 to 5 of a specific webtoon), a gift voucher provided at random times by service providers or provided by a third party, an event voucher granted when specific conditions are met, and a free chargeable voucher charged for free at regular intervals. Here, the free chargeable voucher may be divided into a first free chargeable voucher that can be freely used regardless of the type of content among the set content, and a second free chargeable voucher that can be used only for specific content.

Here, if multiple vouchers can be used for the same content and the user does not specify a specific voucher to be used, the initial voucher, the second free chargeable voucher, the first free chargeable voucher, the event voucher, the gift voucher, and the payment voucher may be exhausted in the order.

The event voucher includes a mission voucher granted to the user when a predetermined mission is satisfied. In one example, a predetermined mission includes sending a particular message to one or more other users.

In addition, when a voucher purchase request is received through a voucher purchase required screen, the server 100 transmits a payment request for an amount corresponding to the voucher purchase request to the card company or financial institution server 300 to perform a series of payment processes. For billing processing, when personal financial information necessary for payment, such as credit card information or financial institution account information, is received from the user terminal 200, the server 100 may request payment from the card company or financial institution server 300 based on the received personal financial information. Here, the financial institution server collectively refers to all institutions dealing with financial affairs, and may include, for example, all banks, securities companies, and the like.

When a payment completion notification is received from the card company or financial institution server 300, the server 100 may generate voucher information in the user account associated with the user terminal 200.

Referring to FIG. 1, the server 100 may be configured to include a voucher management unit 110, a content providing unit 120, a storage unit 130, and an information providing unit 140.

The voucher management unit 110 may manage an initial voucher, a free chargeable voucher, an event voucher, a gift voucher, and a payment voucher.

In particular, the voucher management unit 110 may set a plurality of pieces of target content, which are subject to the free chargeable voucher, among the plurality of pieces of content, and automatically charges a certain number of free chargeable vouchers to the user terminal 200 at certain time intervals. For example, a total of 10 free chargeable vouchers, 5 each at 12 p.m. and 12 a.m., may be charged to the user terminal 200 every day.

The voucher management unit 110 may set and change the time and number of charging of the free chargeable voucher. However, in order to imprint a fixed charging schedule on the user, frequent changes are not desirable.

The voucher management unit 110 may independently set the target content subject to the first free chargeable voucher and the target content subject to the second free chargeable voucher. That is, the voucher management unit 110 may set at least one of the first and second free chargeable vouchers for specific content.

Here, the first free chargeable voucher has a greater right than the second free chargeable voucher because the selection of available content is wider than that of the second free chargeable voucher. Therefore, when the first and second free chargeable vouchers are respectively charged to the target content, the voucher management unit 110 may exhaust the second free chargeable voucher before the first free chargeable voucher.

The voucher management unit 110 may set an application period of the free chargeable voucher for the target content. Here, the user may be provided with the target content by using the free chargeable voucher only for a set application period.

The free chargeable voucher means the user's right to view content for free for a certain period of time, and the free chargeable voucher provided from the server 100 can be used until the next charging. In the aforementioned example, the free chargeable voucher charged at 12:00 p.m. can only be used before 12:00 a.m., and if only two are used before 12 a.m., unused three will disappear at 12:00 a.m. and five new ones will be charged.

As described above, since the free chargeable voucher can be used until the next charging, the user wants to use the free chargeable voucher as much as possible before the next charging, and the frequency of using the free chargeable voucher-based content providing services increases. As a result, the user's loyalty and dependence on the free chargeable voucher-based content providing services can increase.

In addition, when the free chargeable voucher is used for a lot of content, the user can more reliably decide whether or not to purchase the experienced content. After all, it can help the user's rational consumption.

When a request is received from the user terminal 200 to provide target content, the voucher management unit 110 may grant the user terminal 200 the right to view the target content while exhausting the free chargeable voucher.

The target content may be composed of a plurality of episodes, and the voucher management unit 110 may set only some of the plurality of episodes as being subject to the free chargeable voucher. For example, the latest 5 episodes among the plurality of episodes of the target content may be set as being non-subject to the free chargeable voucher.

When a request is received from the user terminal 200 to provide target content, the content providing unit 120 may provide the target content to the user terminal 200.

The storage unit 130 may store content information regarding the plurality of pieces of content, setting information regarding setting of the plurality of pieces of target content, and voucher information regarding charging and use of the free chargeable voucher.

The information providing unit 140 may provide content information, setting information regarding setting of a plurality of pieces of target content, and voucher information to the user terminal.

The free chargeable voucher-based content providing system according to an embodiment of the present invention may be entirely hardware, or may have aspects that are partially hardware and partially software. Accordingly, the user terminal 200 and the server 100 and each component included therein may collectively refer to hardware and related software for processing data of a specific format and content or sending and receiving data in an electronic communication method.

Referring to FIG. 1, each component of the server 100 is communicatively connected to each other, but does not necessarily constitute one physically integrated device. For example, the storage unit 130 may be individual servers or computing devices located to communicate with each other in a distributed computing environment. In addition, the devices are only functionally divided according to the operations performed in the computing device in which each component is implemented, and do not necessarily mean separate devices separated from each other. For example, the voucher management unit 110, the content providing unit 120, and the information providing unit 140 do not necessarily mean separate devices separated from each other.

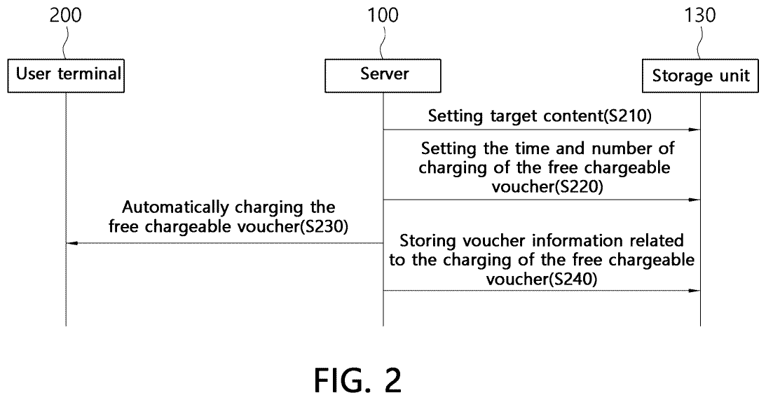

FIG. 2 is a diagram for explaining a process of charging a free voucher in a free chargeable voucher-based content providing system according to an embodiment of the present invention.

Referring to FIG. 2, the server 100 may set a plurality of pieces of target content, which are subject to the free chargeable voucher, among the plurality of pieces of content (S210), and set the time and number of charging of the free chargeable voucher (S220). In this case, the time and number of charging of the free chargeable voucher may be stored in the storage unit 130.

Next, the server 100 may automatically charge the user terminal 200 with a set number of the free chargeable vouchers at the set charging time (S230). For example, the server 100 may automatically charge the user terminal 200 with a total of 10 free chargeable vouchers, 5 each at 12 p.m. and 12 a.m. every day.

Next, after charging the free chargeable voucher to the user terminal 200, the server 100 may store voucher information related to the charging of the free chargeable voucher in the storage unit 130.

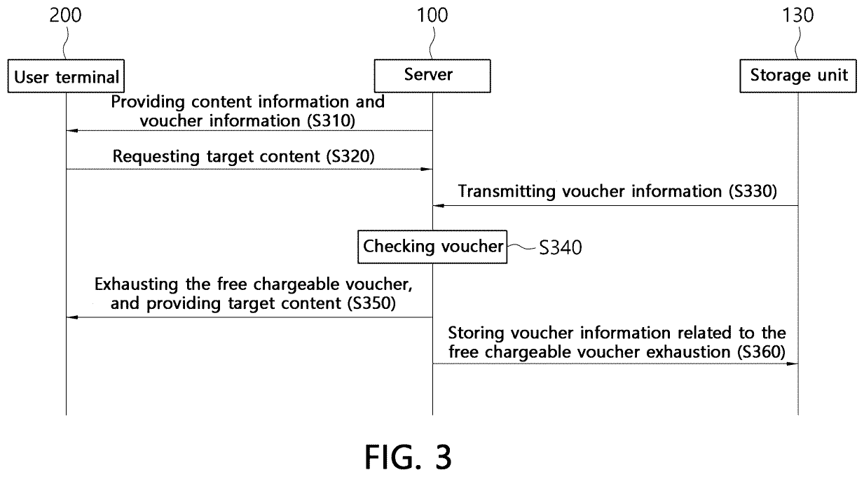

FIG. 3 is a view for explaining a process of providing content based on a free chargeable voucher.

The server 100 is configured to perform the function of the application by communicating with the application executed on the user terminal 200. Specifically, the server 100 operates a server-based service that supports any applications that may be stored in the user terminal 200 or a terminal application for performing a free chargeable voucher-based content providing method.

In particular, the server 100 may distribute content such as webtoons, web novels, digital books, videos, etc. to the user terminal 200 according to whether or not there is a free chargeable voucher, whereby the terminal application installed in the user terminal 200 may transmit a request for provision of content to the server 100 in response to a user's request and receive content from the server 100.

Referring to FIG. 3, the server 100 provides a plurality of content information and free chargeable voucher information to the user terminal 200 (S310). Then, the user terminal 200 requests the server 100 to provide the target content based on the plurality of content information and free chargeable voucher information (S320).

Next, the server 100 receives a request for content provision from the user terminal 4 and information about the free chargeable voucher from the storage unit 130, and check whether or not the free chargeable voucher of the user terminal 200 is present or valid (S340). When the user terminal 200 has a valid free chargeable voucher, the requested content is provided to the user terminal 200 (S350).

In this case, the server 100 may give the user terminal 200 the right to read the target content while exhausting the free chargeable voucher, and store voucher information related to the free chargeable voucher exhaustion in the storage unit 130 (S360).

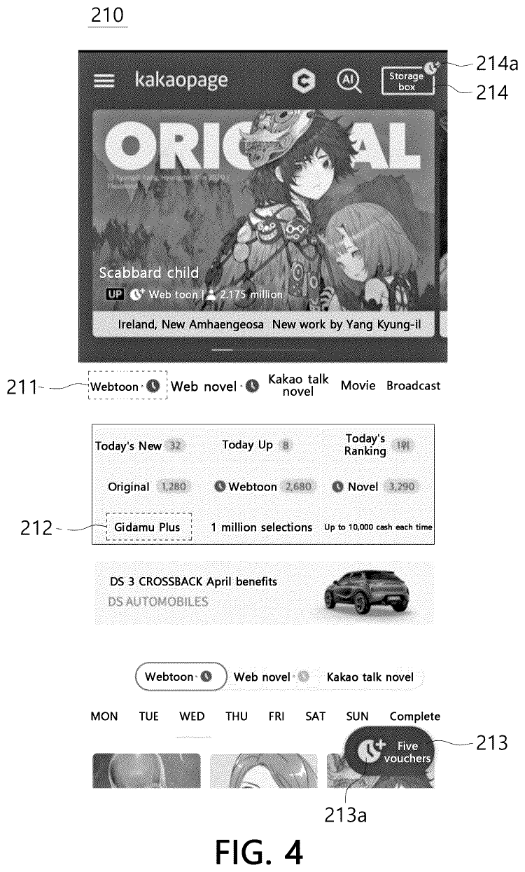

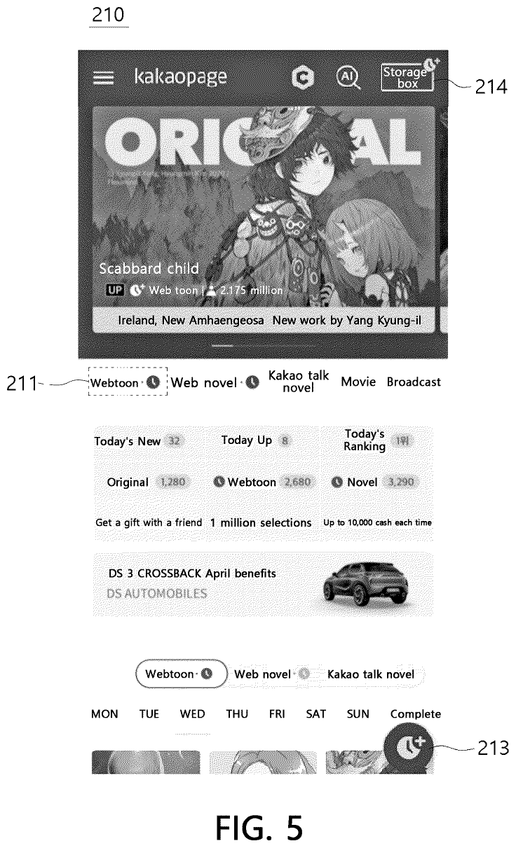

FIG. 4 is a diagram illustrating a main home screen displayed on a user terminal in a free chargeable voucher-based content providing system according to an embodiment of the present invention, and FIG. 5 is a diagram illustrating the main home screen when scrolled or when all of the free chargeable vouchers are exhausted in FIG. 4.

Referring to FIG. 4, the information providing unit 140 may transmit, to the user terminal 200, information related to content being served for the user's selection, which is content information, content category information, and voucher information used to display the main home screen 210 where the user is provided with a basic introduction to the content and can select a content category.

The user terminal 200 may display a main home screen 210 when an application for receiving content based on a free chargeable voucher is executed.

The user terminal 200 may display a plurality of category tabs 211 corresponding to a plurality of categories in which a plurality of pieces of content are classified by type on the main home screen 210. For example, the user terminal 200 may display a webtoon tab, a web novel tab, a movie tab, a broadcast tab, and the like in one area (e.g., stop) of the main home screen 210.

When the category tab 211 includes target content subject to the free chargeable voucher, the user terminal 200 may expose a badge indicating the free chargeable voucher on the category tab 211. Accordingly, it is possible to induce the user to use the free chargeable voucher.

The user terminal 200 may display the free use tab 212 corresponding to a plurality of pieces of target content in one area (e.g., stop) of the main home screen 210. Here, the target content refers to a content subject to the free chargeable voucher among the plurality of pieces of content.

When the user selects (e.g., touches or clicks) the free use tab 212, the user terminal 200 may move from the main home screen 210 to a free use home screen 230 to be described later.

The user terminal 200 may expose a floating button 213 including voucher information in an area (e.g., bottom right) of the main home screen 210. Here, the floating button 213 may display a badge 213a indicating the free chargeable voucher and the remaining number of the free chargeable vouchers. For example, when the first 5 free chargeable vouchers are received from the server 100 and none of them are exhausted, the initially received 5 vouchers may be displayed.

When the user selects (e.g., touches or clicks) the floating button 213, the user terminal 200 may move from the main home screen 210 to a free use home screen 230 to be described later.

The floating button 213 refers to a button capable of attracting a user's attention and inducing a specific action with an intuitive design. The floating button 213 is preferably arranged in consideration of the degree of occlusion of the content tab or the category tab and the user's behavior and tendency to use the application in order to give a positive experience to the user.

Specifically, in the present invention, by disposing the floating button 213 at the bottom of the screen, when the user holds the user terminal 200 with one hand, the user can easily press the floating button 213 with his thumb, thereby increasing accessibility.

The user terminal 200 may display a storage box tab 214 corresponding to a storage box storing a voucher in one area (e.g., upper right side) of the main home screen 210.

Here, when the free chargeable voucher is charged, it may be stored in the storage box of the user terminal 200.

The user terminal 200 may expose a badge 214a indicating the free chargeable voucher on the storage box tab 214 for a predetermined time (e.g., 1 hour) after charging the free chargeable voucher. Accordingly, it is possible to induce the user to use the free chargeable voucher.

When the user selects (e.g., touches or clicks) the storage box tab 214 and selects (e.g., touches or clicks) the free chargeable voucher stored in the storage box, the user terminal 200 may move from the main home screen 210 to a free use home screen 230 to be described later.

Referring to FIG. 5, the floating button 213 may be exposed in a reduced form when the main home screen 210 is scrolled or when all of the free chargeable vouchers are exhausted. For example, in the floating button 213, the remaining number of free chargeable vouchers may be deleted and only the badge 213a indicating the free chargeable voucher may be displayed.

As such, the reason for exposing the floating button 213 in a reduced form is that the floating button 213 is floating on the screen, so it may cause inconvenience to the user by covering the content tab or the category tab at the bottom thereof. Since the user is highly likely to recognize and scroll the floating button 213 when scrolling the main home screen 210, the present invention minimizes the covering of the content tab or category tab by exposing the floating button 213 in a reduced form.

Similarly, when all of the free chargeable vouchers are exhausted, there is no reason for the user to select the floating button 213, so the present invention minimizes the covering of the content tab or category tab by exposing the floating button 213 in a reduced form.

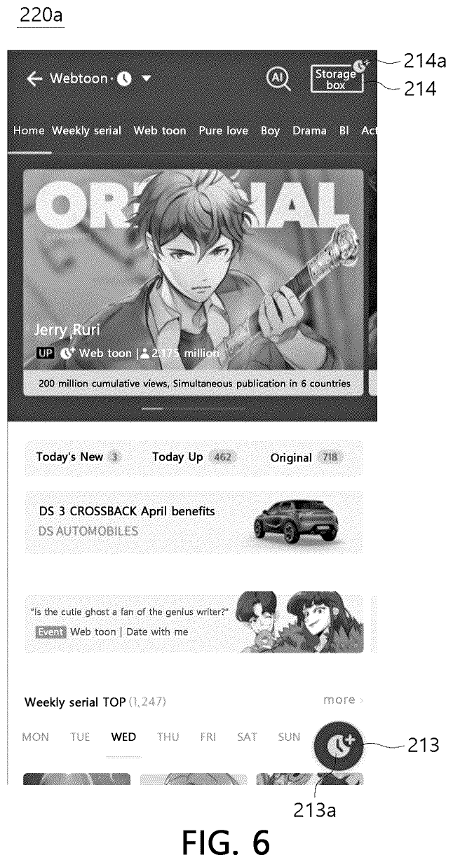

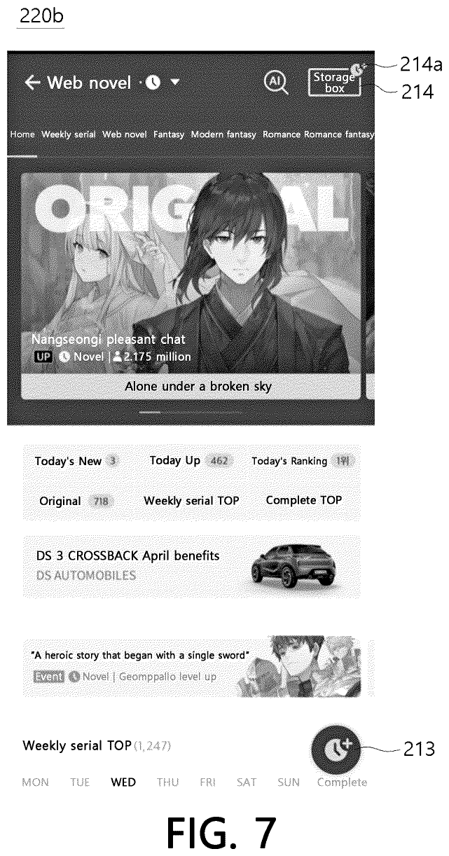

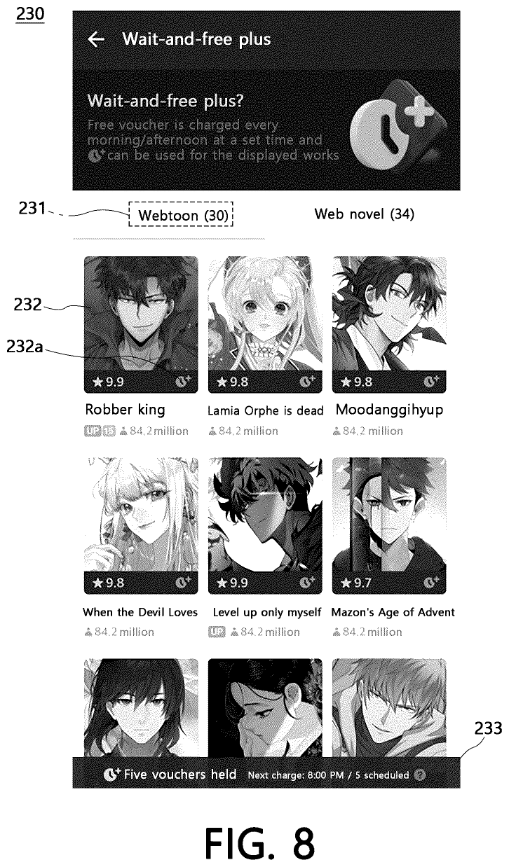

FIGS. 6 and 7 are diagrams illustrating a category home screen displayed on a user terminal in a free chargeable voucher-based content providing system according to an embodiment of the present invention, and FIG. 8 is a diagram illustrating a free use home screen displayed on a user terminal in a free chargeable voucher-based content providing system according to an embodiment of the present invention.

Referring to FIGS. 6 and 7, when the user selects (e.g., touches or clicks) one of a plurality of category tabs 211 displayed on the main home screen 210, the user terminal 200 may move to category home screens 220a and 220b corresponding to the selected category tab 211. For example, when the user selects the webtoon tab displayed on the main home screen 210, the user terminal 200 may move to the webtoon home screen 220a as shown in FIG. 6, and when the user selects the web novel tab displayed on the main home screen 210, the user terminal 200 may move to the web novel home screen 220b as shown in FIG. 7.

The category home screens 220a and 220b may display a plurality of content tabs included in a corresponding category.

When the user selects (e.g., touches or clicks) any one of the plurality of content tabs, the user terminal 200 may move from the category home screens 220a and 220b to the selected content home screen.

The user terminal may expose the floating button 213 in a reduced form on the category home screens 220a and 220b.

As such, the reason for exposing the floating button 213 in a reduced form is that the floating button 213 is floating on the screen, so it may cause inconvenience to the user by covering the content tab or the category tab at the bottom thereof. Since the user is highly likely to recognize and move the voucher information included in the floating button 213 when moving from the main home screen 210 to the category home screens 220a and 220b, the present invention minimizes the covering of the content tab by exposing the floating button 213 in a reduced form.

When the user selects (e.g., touches or clicks) the floating button 213, the user terminal 200 may move from the category home screens 220a and 220b to a free use home screen 230 to be described later.

Referring to FIG. 8, when the user selects (e.g., touches or clicks) the floating button 213 displayed on the main home screen 210 and the category home screens 220a and 220b, the user terminal 200 may move to the free use home screen 230.

The user terminal 200 may display a plurality of target category tabs 231 corresponding to a plurality of target categories in which a plurality of pieces of target content are classified by type on the free use home screen 230.

Here, at least one of a webtoon, a web novel, a movie, and a broadcast may be set as the target category.

When the user selects (e.g., touches or clicks) any one of the plurality of target category tabs 231 displayed on the free use home screen 230, the user terminal 200 may display a plurality of target content tabs 232 included in the selected target category tab 231.

If the current category home screen 220a is the webtoon home screen 220a as shown in FIG. 6 and the user selects the floating button 213 on the webtoon home screen 220a, the user terminal 200 may display a plurality of target content tabs 232 corresponding to webtoons on the free use home screen 230.

In addition, if the current category home screen 220a is the web novel home screen 220b as shown in FIG. 7 and the user selects the floating button 213 on the web novel home screen 220b, the user terminal 200 may display a plurality of target content tabs 232 corresponding to web novels on the free use home screen 230.

As such, the present invention can provide convenience to the user by reflecting a category in which the user is currently interested when moving from the category home screens 220a and 220b to the free use home screen 230.

In contrast, when the floating button 213 is selected on the main home screen 210, the user terminal 200 may display a plurality of target content tabs 232 corresponding to a preset target category (e.g., webtoon) on the free use home screen (230).

The user terminal 200 may display a plurality of target content tabs 232 in the form of thumbnails. Here, the target content tab 232 may include related information, such as a content title, rating, and number of viewers.

The user terminal 200 may expose a badge 232a indicating a free chargeable voucher on the plurality of target content tabs 232. Here, when the time set as the target content is earlier than the time when the user enters the free use home screen 210, the badge 232a may be exposed. Accordingly, it is possible to induce the user to use the free chargeable voucher.

In addition, the user terminal 200 may display the voucher information 233 including a badge indicating a free chargeable voucher, the remaining number of free chargeable vouchers, the next charging time and charging number, and tips in one area of the free use home screen 210 (e.g., bottom).

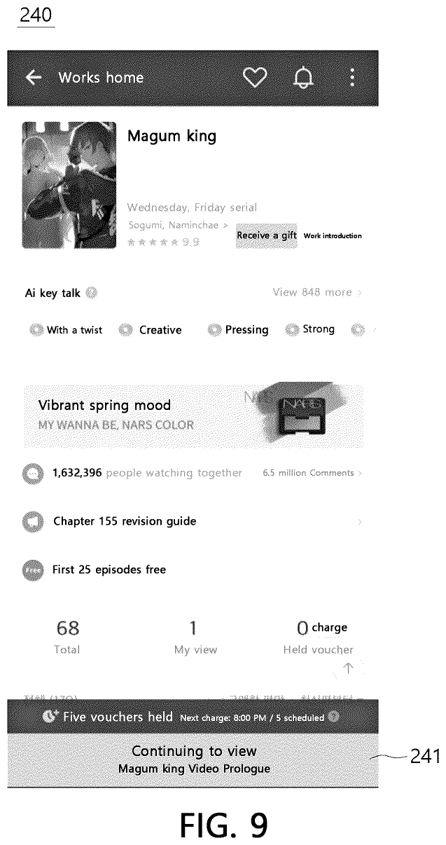

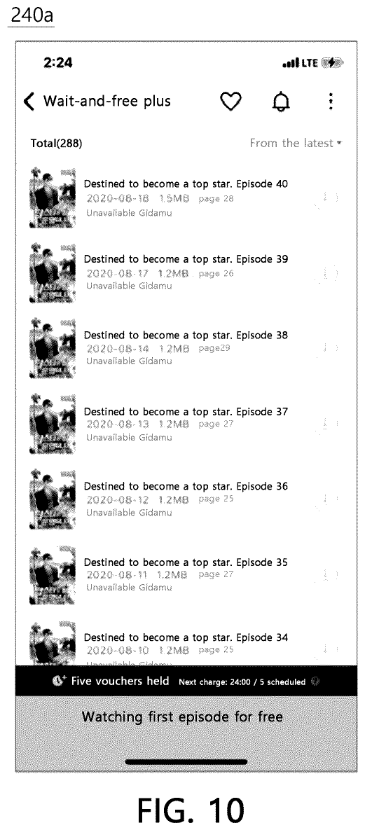

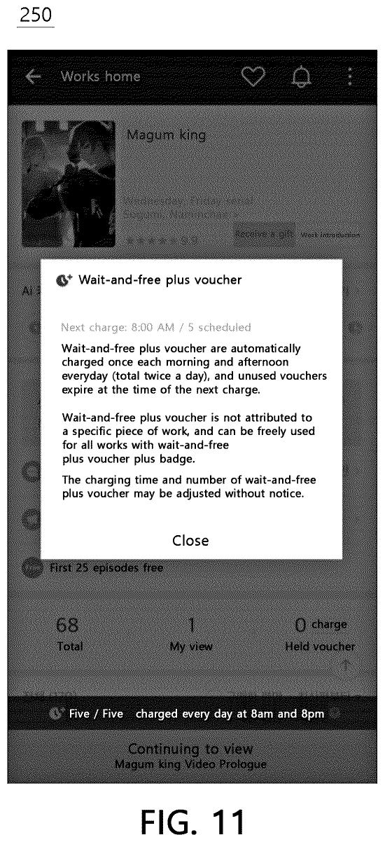

FIG. 9 is a diagram illustrating a target content home screen displayed on a user terminal in a free chargeable voucher-based content providing system according to an embodiment of the present invention, FIG. 10 is a diagram illustrating a target content list screen displayed on a user terminal in a free chargeable voucher-based content providing system according to an embodiment of the present invention, and FIG. 11 is a diagram illustrating a description of a free chargeable voucher displayed on a user terminal in a free chargeable voucher-based content providing system according to an embodiment of the present invention.

Referring to FIG. 9, when the user selects (e.g., touches or clicks) the target content 232 displayed on the free use home screen 230, the user terminal 200 may move to the target content home screen 240.

The user terminal 200 may display the selected target content tab 242 on the target content home screen 240. Here, the user terminal 200 may display the target content tab 242 in the form of a thumbnail. Here, the target content tab 242 may include related information, such as a content title, rating, and number of viewers.

The user terminal 200 may display an execution tab 241 through which the target content can be reproduced or continued to be viewed on the target content home screen 240.

In addition, the user terminal 200 may display the voucher information 233 including a badge indicating a free chargeable voucher, the remaining number of free chargeable vouchers, the next charging time and charging number, and tips in one area of the target content home screen 240 (e.g., bottom).

Referring to FIG. 10, when the user selects (e.g., touches or clicks) the target content tab 242 displayed on the target content home screen 240, the user terminal 200 may move to the target content list screen 240a.

Here, when only some of the entire episodes of the target content are set to be subject to the free chargeable voucher, the user terminal 200 may display the phrase “not available for viewing” for the episodes that are not subject to the application.

In addition, the user terminal 200 may display the voucher information including a badge indicating a free chargeable voucher, the remaining number of free chargeable vouchers, the next charging time and charging number, and tips in one area of the target content list screen 240a (e.g., bottom).

On the other hand, when the user selects (e.g., touches or clicks) an episode that is not subject to the free chargeable voucher among the target content, a voucher use confirmation pop-up window may be exposed. Here, the pop-up window may display the initial voucher, event voucher, gift voucher, and payment voucher held by the user. Here, the voucher held by the user may include a rental right and a collection right. Accordingly, the user can select and exhaust any one of the vouchers owned by him to view episodes that are not subject to the free chargeable voucher. On the other hand, if there is no voucher held, the user may move to a payment home screen where the user can pay for the voucher.

Referring to FIG. 11, when the user selects help (e.g., a question mark) displayed on the free use home screen 230 or the target content home screen 240, the user terminal 200 displays a description of the free chargeable voucher. For example, the user terminal 200 may display “The next charge is scheduled to be charged with five free chargeable vouchers at 8:00 a.m., the free chargeable vouchers are automatically charged once each morning and afternoon every day (total twice a day), and unused vouchers will expire at the time of the next charge. The free chargeable voucher is not attributed to a specific piece of work, and can be freely used for all works with a badge indicating the free chargeable voucher. The charging time and number of the free chargeable vouchers may be adjusted without notice.”

In the above, embodiments of the free chargeable voucher-based content providing method and system of the present invention have been described. The technical features disclosed in each embodiment of the present invention are not limited to the embodiment, and unless they are incompatible with each other, the technical features disclosed in each embodiment may be applied and combined to other embodiments.

The present invention is not limited to the above-described embodiments and the accompanying drawings, and various modifications and variations will be possible from the point of view of those skilled in the art to which the present invention pertains. Accordingly, the scope of the present invention should be defined not only by the claims of the present application but also by the equivalent to these claims.

The present invention described above can be implemented as computer-readable code (or application or software) on a medium in which a program is recorded. The above-described generation method may be realized by a code stored in a memory or the like.

The computer-readable medium includes all kinds of recording devices in which data readable by a computer system is stored. Examples of computer-readable media include hard disk drive (HDD), solid state disk (SSD), silicon disk drive (SDD), ROM, RAM, CD-ROM, magnetic tape, floppy disk, optical data storage device, etc., and also include those implemented in the form of carrier waves (e.g., transmission through the internet). In addition, the computer may include a processor or a control unit. Accordingly, the above detailed description should not be construed as restrictive in all respects and should be considered illustrative. The scope of the present invention should be determined by a reasonable interpretation of the appended claims, and all modifications within the equivalent scope of the present invention are included in the scope of the present invention.

The free chargeable voucher-based content providing system according to the present invention may be used in a digital device, a platform business server, a digital cloud, and the like.

What is claimed is:

1. A free chargeable voucher-based content providing system for providing a plurality of pieces of content on the basis of a free chargeable voucher, the system comprising:
a voucher management unit which manages a free chargeable voucher that allows the plurality of pieces of content to be used for free, sets a plurality of pieces of target content, which are subject to the free chargeable voucher, among the plurality of pieces of content, and automatically charges a certain number of the free chargeable vouchers to a user terminal at certain time intervals;
a content providing unit which, when a request is received from the user terminal to provide the target content on the basis of the free chargeable voucher, provides the target content to the user terminal; and
a storage unit which stores content information regarding the plurality of pieces of content, setting information regarding setting of the plurality of pieces of target content, and voucher information regarding charging and use of the free chargeable voucher.

2. The free chargeable voucher-based content providing system according to claim 1, wherein the voucher management unit sets the time and number of charging of the free chargeable voucher.

3. The free chargeable voucher-based content providing system according to claim 1, wherein when a request is received from the user terminal to provide the target content, the voucher management unit grants the user terminal the right to view the target content while exhausting the free chargeable voucher.

4. The free chargeable voucher-based content providing system according to claim 1, wherein the free chargeable voucher can be used until the next charging.

5. The free chargeable voucher-based content providing system according to claim 1, wherein the free chargeable voucher includes a first free chargeable voucher that can be used for all of the plurality of pieces of target content, and a second free chargeable voucher that can be used only for specific content among the plurality of pieces of target content.

6. The free chargeable voucher-based content providing system according to claim 5, wherein when the first and second free chargeable vouchers are respectively charged to the target content, the voucher management unit exhaust the second free chargeable voucher before the first free chargeable voucher.

7. The free chargeable voucher-based content providing system according to claim 1, further including the information providing unit for providing the content information, the setting information regarding setting of the plurality of pieces of target content, and the voucher information to the user terminal.

8. The free chargeable voucher-based content providing system according to claim 7, wherein the user terminal exposes a floating button including the voucher information on the main home screen.

9. The free chargeable voucher-based content providing system according to claim 8, wherein the floating button is exposed in a reduced form when the main home screen is scrolled or when all of the free chargeable vouchers are exhausted.

10. The free chargeable voucher-based content providing system according to claim 8, wherein the floating button displays a badge indicating the free chargeable voucher and the remaining number of the free chargeable vouchers.

11. The free chargeable voucher-based content providing system according to claim 8, wherein the user terminal displays a plurality of category tabs corresponding to a plurality of categories in which the plurality of pieces of content are classified by type on the main home screen.

12. The free chargeable voucher-based content providing system according to claim 11, wherein when the user selects one of the plurality of category tabs, the user terminal moves to a category home screen corresponding to the selected category tab.

13. The free chargeable voucher-based content providing system according to claim 12, wherein the user terminal exposes the floating button in a reduced form on the category home screen.

14. The free chargeable voucher-based content providing system according to claim 8, wherein the user terminal displays free use tabs corresponding to the plurality of pieces of target content on the main home screen.

15. The free chargeable voucher-based content providing system according to claim 14, wherein when the user selects the free use tab, the user terminal moves to a free use home screen corresponding to the target content.

16. The free chargeable voucher-based content providing system according to claim 14, wherein when the user selects the floating button, the user terminal moves to a free use home screen corresponding to the target content.

17. The free chargeable voucher-based content providing system according to claim 8, wherein the user terminal displays a storage box tab corresponding to a storage box for storing the free chargeable voucher on the main home screen.

18. The free chargeable voucher-based content providing system according to claim 17, wherein the user terminal exposes a badge indicating the free chargeable voucher on the storage tab for a certain period of time after charging the free chargeable voucher.

19. The free chargeable voucher-based content providing system according to claim 1, wherein the user terminal exposes a badge indicating the free chargeable voucher on the plurality of pieces of target content.
